(19) United States
(12) Patent Application Publication
(10) Pub. No.: US 2021/0263985 A1
(43) Pub. Date: Aug. 26, 2021

(54) Database Query Methods and Systems Using Machine-Readable Optical Codes

(71) Applicant: PIIQ Technologies, Inc., New York, NY (US)

(72) Inventor: Austin Lo, New York, NY (US)

(73) Assignee: PIIQ Technologies, Inc., New York, NY (US)

(21) Appl. No.: 17/180,225

(22) Filed: Feb. 19, 2021

Related U.S. Application Data
(60) Provisional application No. 62/979,611, filed on Feb. 21, 2020.

(51) Int. Cl. G06F 16/9537; G06F 16/29; G06F 16/955; G06Q 50/16; G06F 16/9538; G06K 7/14

(52) U.S. Cl. CPC G06F 16/9537; G06F 16/29; G06F 16/9554; G06K 7/1417; G06Q 50/163; G06F 16/9538; G06F 16/9566

(57) ABSTRACT

Systems and methods for database querying using machine-readable optical codes are provided. A system receives machine-readable optical code information associated with a listing entity from a user device, determines the listing entity based on the received optical code information, and retrieves one or more property listings associated with the listing entity from a database. The system receives geolocation data of the user device and filters the property listings based on the geolocation data to determine a first property listing having a closest proximity to the user device. The system transmits the first property listing to the user device for display. A method for database querying involves determining a listing entity based on computer-readable optical code information that is associated with the listing entity and received from a user device. One or more property listings are retrieved from a database and filtered based on received geolocation data of the user device.

### RELATED APPLICATIONS

This application claims priority to U.S. Provisional Patent Application Ser. No. 62/979,611 filed on Feb. 21, 2020, the entire disclosure of which is hereby expressly incorporated by reference

### BACKGROUND

### Technical Field

The present disclosure relates generally to the field of computer database querying technology. More specifically, the present disclosure relates to a method and system for querying a database utilizing a machine-readable optical code, and obtaining filtered information from the database based on the machine-readable optical code scanned by a user device.

### Related Art

In the field of computer database querying, systems and methods can utilize machine-readable optical codes, e.g., a Quick Response (QR) code, to access information tied to that code. That is, machine-readable optical codes can be used to uniquely identify a unit or an item associated therewith. However, such systems and methods are problematic because the amount of information the machine-readable optical code can provide is limited, and linked to that specific code.

In the real estate field, it is imperative to allow potential buyers to easily access real estate listings that they may be interested in, and to do so in real-time. For example, a potential purchaser may see a building having a posted real estate sign and be interested in that particular property. In such a situation, the potential purchaser may have to conduct several searches on various websites until they find the specific listing. This process can be time consuming, and it is not guaranteed that the potential purchaser will always find the property that they are interested in, which can be frustrating and possibly result in a lost sale.

Thus, systems and methods for providing ancillary information related to a machine-readable optical code, and simplifying real estate searching is needed. Accordingly, the systems and methods of the present disclosure address these and other needs.

### SUMMARY

A system for database querying using machine-readable optical codes includes a database and a processor in communication with the database. The processor can have a query module, and can receive machine-readable optical code information associated with a listing entity from a user device. The processor can determine the listing entity based on the received computer-readable optical code information, and can retrieve one or more property listings associated with the entity from the database. The processor can also receive geolocation data of the user device, and filter the one or more property listings based on the received geolocation data to determine a first property listing having a closest proximity to the user device. Next, the processor transmits the first property listing to the user device, which is configured to display the first property listing.

Another system for database querying using machine-readable optical codes includes a database and a processor in communication with the database. The processor can have a query module, and can receive machine-readable optical code information from a user device used to scan the machine-readable optical code associated with the real estate property listing. The processor identifies the real estate property listing associated with the scanned machine-readable optical code based on the received machine-readable optical code information and displays the real estate property listing on a display of the user device.

The system could be implemented in a cloud-based environment wherein centralized, cloud-based monitoring and control of a network of machine-readable optical codes is provided. Moreover, the system could function as a centralized portal for allowing real estate professionals, buyers and sellers, as well as for allowing insurers and other entities to access real estate property listing data, as needed, in the field.

### BRIEF DESCRIPTION OF THE DRAWINGS

The foregoing features of the present disclosure will be apparent from the following Detailed Description of the Invention, taken in connection with the accompanying drawings in which:

FIG. 1 is a diagram illustrating an overview of a system of the present disclosure;

FIG. 2 is a flowchart illustrating processing steps carried out by an embodiment of the system of the present disclosure;

FIG. 3 is a diagram illustrating a display of a user device according to step 44 of FIG. 2;

FIG. 4 is a flowchart illustrating processing steps carried out by an embodiment of the system of the present disclosure

FIG. 5 is a diagram illustrating an exemplary display of a user device according to step 96 of FIG. 4;

FIG. 6 is a diagram illustrating another exemplary display of a user device according to step 96 of FIG. 4;

FIG. 7 is a screenshot illustrating an exemplary user interface displayed on a display of a user device according to step 96 of FIG. 4; and

FIG. 8 is a screenshot illustrating an exemplary user interface showing available properties after filtering utilizing the user interface of FIG. 7.

### DETAILED DESCRIPTION

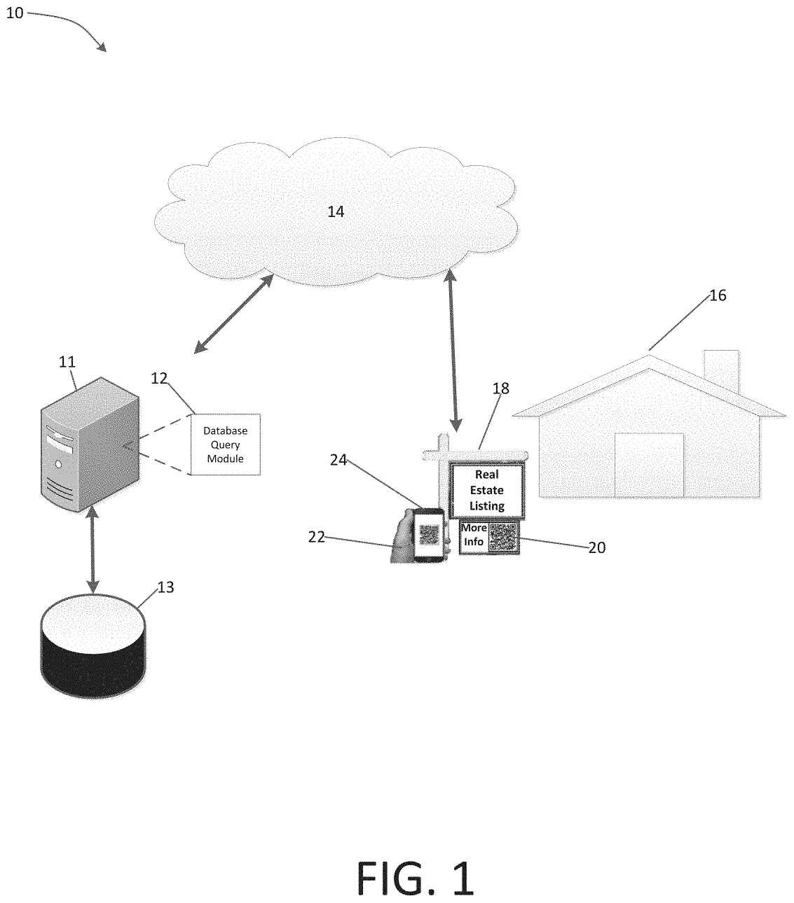

The present disclosure relates to systems and methods for improved database querying using machine-readable optical codes, as described in detail below in connection with FIGS. 1-6.

Turning to the drawings, FIG. 1 is a diagram illustrating an overview of a system of the present disclosure generally indicated as system 10. The system 10 can include a server 11 having a database query module 12, a database 13 in communication with the server 11, a network 14, a real estate property listing machine-readable optical code 20, e.g., a QR Code, associated with a property 16, and a user device 24 operated by a user 22. The network 14 facilitates communication and provides for secure data transport and exchange between the various components of the system 10. The machine-readable optical code 20 could be provided in addition to, or as part of, a conventional listing signage 18 (e.g., a “For Sale” sign, an “Open House” sign, or a real estate agency sign). In addition, the property 16 could include, but is not limited to, a single family home, an apartment, a condominium, a townhouse, commercial real estate, an automobile, a watercraft, etc. The user device 24 could include, but is not limited to, a tablet, a smart telephone, a personal digital assistant (PDA), and/or a cloud-based computing platform.

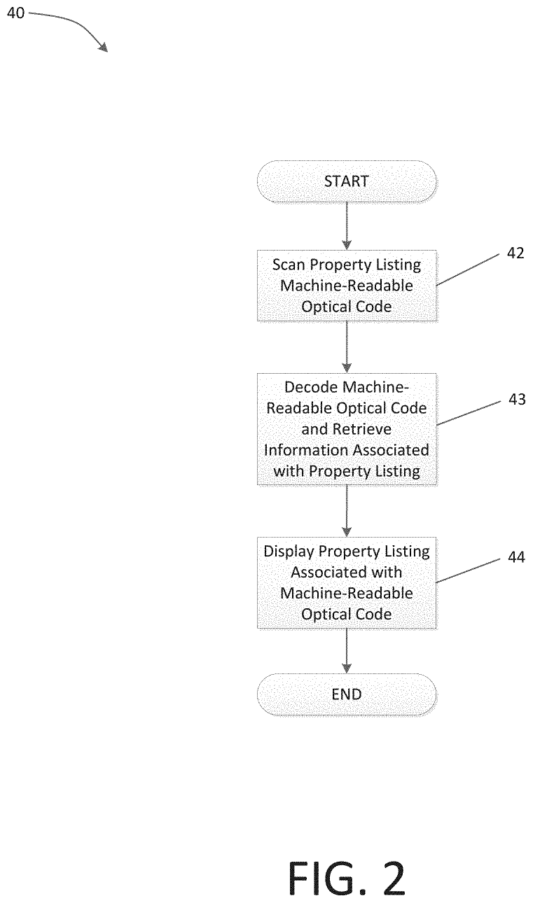

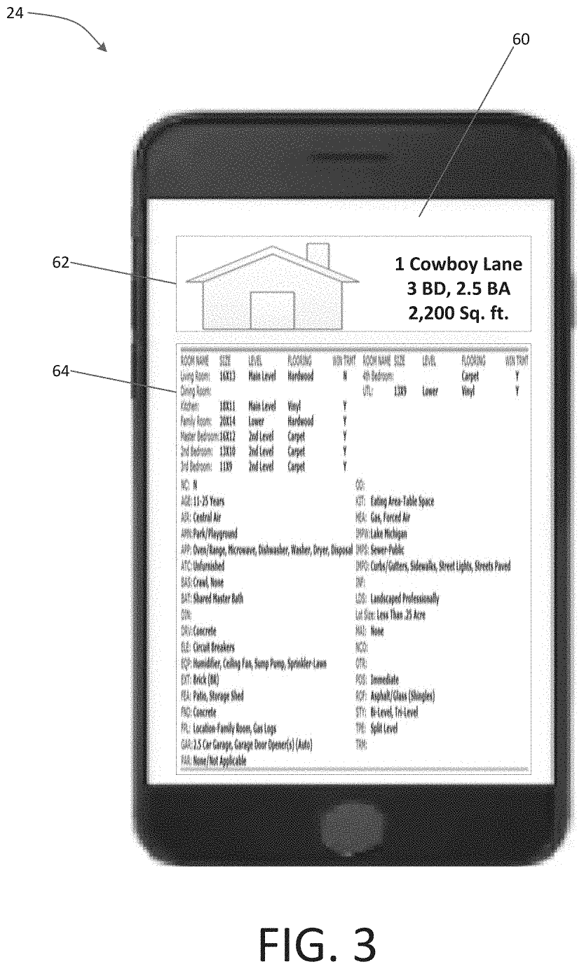

FIG. 2 is a flowchart 40 illustrating processing steps carried out by an embodiment of the system of the present disclosure. In step 42, a user 22 scans the machine-readable optical code 20 associated with the property 16 using the device 24. For example, the device 24 can include native machine-readable optical code scanning software that can be used to scan the machine-readable optical code 20. In step 43, the device 24 decodes the machine-readable optical code 20 to determine the property associated with the code 20, and retrieves information for the property 16 associated with the scanned code 20 from the server 11. Then, in step 44, the system 10 the retrieved information for the property 16 is displayed on a display 60 (see FIG. 3) of the user device 24. For example, the server 11 can transmit a web site link for the property 16 to the user device 24, which can be automatically opened and displayed to the user. As shown in FIG. 3, the displayed information could include a property summary 62 and detailed property information 64. The property summary 62 could include, but is not limited to, an address, a number of bedrooms and/or bathrooms, and a square footage of the property 16. The detailed property information 64 could include, but is not limited to, an age, floor type(s), lot size, etc., of the property 16.

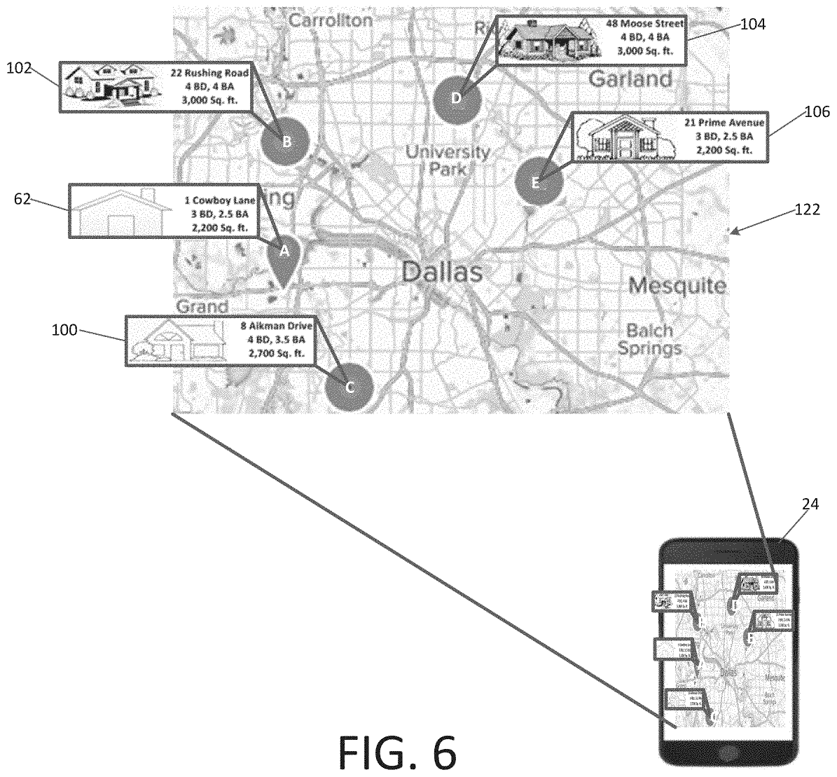

Alternatively, an interactive street view of the property 16, e.g., via a web browser, can be displayed on the device display 60, which can allow the user to view the property 16 and explore the neighborhood. The user can also zoom out from the street view to view a plan view of the property 16 and neighborhood in order to see other available properties nearby (see, e.g., FIG. 6). Moreover, the foregoing functionality could be combined with a real estate program that allows for three-dimensional virtual property tours. In such an aspect, not only could the exterior of the property 16 be displayed in an interactive street view, but the property 16 could be entered and virtually toured by the user on the device 24. This functionality allows for a user to immediately tour a property 16 of interest at the point of discovery by merely scanning an associated machine-readable optical code 20, e.g., without having to search for the property 16 or physically enter the property 16.

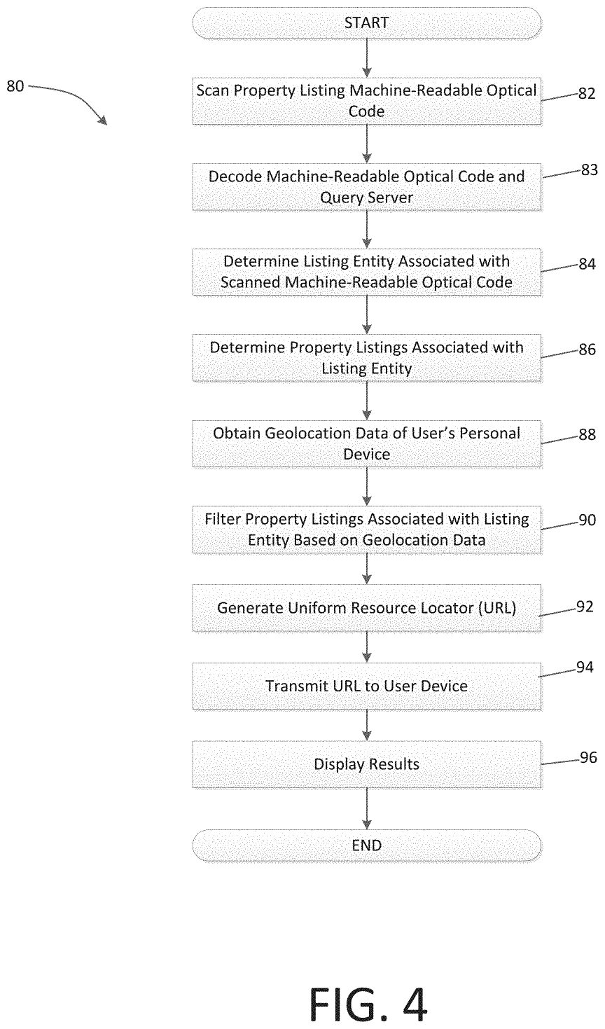

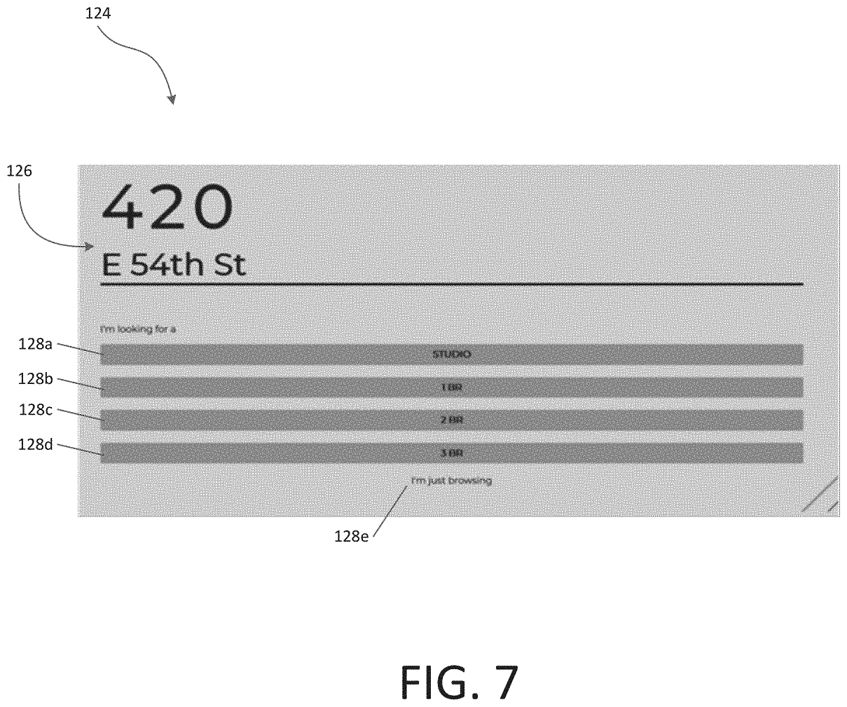

FIG. 4 is a flowchart 80 illustrating processing steps carried out by an embodiment of the system of the present disclosure. In step 82, a user 22 scans the machine-readable optical code 20 provided in front of the property 16 with the device 24. For example, the device 24 can include native machine-readable optical code scanning software that can be used to scan the machine-readable optical code 20. In this aspect, the machine-readable optical code 20 can be associated with and specific to a listing entity, such that all properties for that specific listing entity have the same machine-readable optical code 20 included in the associated listing signage 18. In step 83, the device 24 decodes the machine-readable optical code 20 and queries the server 11 to retrieve information relating to the listing entity associated with the scanned code 20, e.g., real estate brokerage, a real estate broker, a real estate agency, a real estate agent, a realtor, a bank, etc. In step 84, the server 11 receives the query from the device 24, including information related to the scanned code 20, and determines the listing entity associated with the property 16 utilizing the database query module 12. In step 86, the server 11 accesses the database 13 and retrieves one or more property listings associated with the previously determined listing entity. Then, in step 88, the server 11 obtains geolocation data of the device 24. This can be achieved, for example, by associating a token with the scanned machine-readable optical code that causes the server 11 to query the device 24 for its geolocation data. In step 90, the server 11 filters the one or more property listings associated with the previously determined listing entity based on the received geolocation data of the device 24, e.g., according to a proximity of the one or more property listings to the device 24. More specifically, the server 11 compares the geolocation data of the device 24, e.g., the Global Positioning System (GPS) coordinates, to the geolocation data, e.g., the GPS coordinates, of the property listings stored in the database 13 associated with the previously determined listing entity. For example, the server 11 could filter the results to the single property listing that is closest to the device, thus isolating the specific property 16 of interest based on the geolocation data. Alternatively, the server 11 could filter the results based on a set distance from the device, e.g., one mile radius, two mile radius, etc. In step 92, the server 11 generates a unique Uniform Resource Locator (URL), e.g., a web address, for the specific property 16 identified in step 90. This can be done, for example, by populating a customizable property URL with an address parameter that is associated with the specific property 16, such that opening the URL will display a website for the specific property 16 on the user device 24, as shown in FIG. 7 which is discussed below. In step 94, the unique URL is transmitted to the user device 24. In step 96, the unique URL is opened on the user device 24, which can be done automatically, and the website for the specific property 16 is displayed including information for the property 16 and/or information for each of the filtered property listings on the display 60 thereof. Alternatively and/or additionally, a listing of the filtered property listings or a plan view of a geographical area can be displayed. The user can then optionally further filter the properties listed based on various other characteristics, e.g., price, number of bedrooms, number of bathroom, square footage, or any other relevant characteristic of the property being sold.

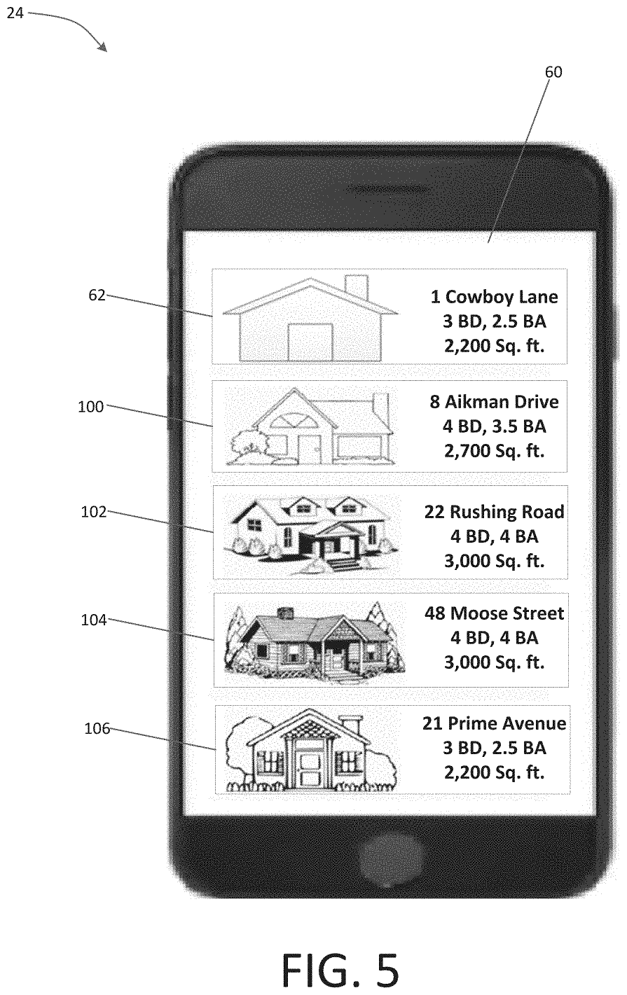

As shown in FIG. 5, the device display 60 could include a property summary 62 and proximate property summaries 100, 102, 104, 106. The property summary 62 and proximate property summaries 100, 102, 104, 106 could include, but are not limited to, an address, a number of bedrooms and/or bathrooms, and a square footage of the respective properties. Alternatively, as shown in FIG. 6 and referenced above, the device display 60 could include an area map 122 illustrating geographic locations A-E corresponding to the property 16 and the proximate properties relating to the property summaries 100, 102, 104, 106 of FIG. 5.

Alternatively, the user can be automatically shown an interactive street view of the property 16, e.g., via a web browser, which can allow the user to view the property 16 and explore the neighborhood. The user can also zoom out from the street view to view the area map 122 illustrated in FIG. 6. Moreover, the foregoing functionality could be combined with a real estate program that allows for three-dimensional virtual property tours. In such an aspect, not only could the exterior of the property 16 be displayed in an interactive street view, but the property 16 could be entered (e.g., automatically or by clicking on the property in the interactive street view) and virtually toured by the user on the device 24. This functionality allows for a user to immediately tour a property 16 of interest at the point of discovery by merely scanning a machine-readable optical code 20 associated with a listing entity, and without having to search for the property 16 or physically enter the property 16.

FIG. 7 is a screenshot illustrating an exemplary user interface 124 displayed on the display 60 of the user device 24 according to step 96 of FIG. 4. As discussed in connection with FIG. 4, the server 11 generates a unique URL, which is transmitted to and opened on the user device 24. The URL can direct a user to a website that displays the user interface 124 shown in FIG. 7. The user interface 124 can display the address 126 of the specific property 16 along with a plurality of filter buttons 128a-e. The filter buttons 128a-e can be used to further specify the specific type of property that is desired where more than one property unit is available at the searched location. For example, this can be useful where the property 16 is an apartment building that has multiple units available for purchase or rent. As shown in FIG. 7, the property can be filtered based on the number of bedrooms. For example, the first filter button 128a can filter the results for studio apartments, the second filter button 128b can filter the results for one bedroom apartments, the third filter button 128c can filter the results for two bedroom apartments, and the fourth filter button 128d can filter the results for three bedroom apartments. The fifth filter button 128e can be used to show all results without further filtering.

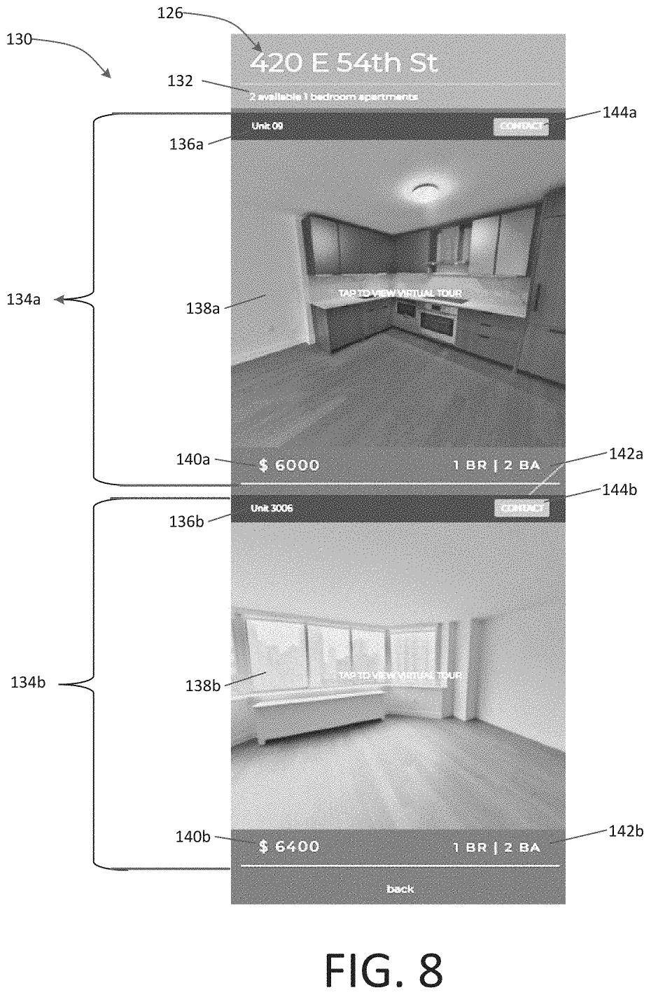

By way of example, if a user wishes to filter the results for one bedroom apartments, the user can click the second filter button 128b, which will filter the results and cause the user interface 130 of FIG. 8 to be displayed which is a screenshot showing available one bedroom properties after filtering according to the user interface 124 of FIG. 7. As shown in FIG. 8, the user interface 130 can display the address 126 of the specific property 16, the number of available units 132 for the specific property 16, and the details 134a, 134b for each available unit. The details 134a, 134b for each available unit can include the unit number 136a, 136b, a picture of the unit 138a, 138b, a price for the unit 140a, 140b, information about the unit 142a, 142b (e.g., the number of bedrooms and bathrooms), and a contact button 144a, 144b for the unit, which can be used to contact the seller or listing agent. The picture of the unit 138a, 138b can be graphical user interface element that when clicked will open a virtual tour of the property/unit, as discussed above. The foregoing functionality allows the user to tour the property/unit without having to enter the building.

Having thus described the present disclosure in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure.

What is claimed is:

1. A system for database querying using at least one machine-readable optical code, comprising:
a database; and
a processor in communication with the database, the processor:
receiving machine-readable optical code information associated with a listing entity from a user device,
determining the listing entity based on the received computer-readable optical code information,
retrieving one or more property listings associated with the listing entity from the database,
receiving geolocation data of the user device,
filtering the one or more property listings based on the received geolocation data to determine a first property listing having a closest proximity to the user device, and
transmitting the first property listing to the user device;
wherein the user device is configured to display the first property listing.

2. The system of claim 1, wherein the machine-readable optical code is a Quick Response (QR) code.

3. The system of claim 1, wherein the listing entity is one of a real estate brokerage, a real estate broker, a real estate agency, a real estate agent, a realtor, and a bank.

4. The system of claim 1, wherein the user device is one of a smart phone, a tablet, a personal digital assistant, and a cloud-based computing platform.

5. The system of claim 1, wherein property associated with the property listing is one of a single family home, an apartment building, an apartment, a condominium, a townhouse, a commercial building, an automobile, and a watercraft.

6. The system of claim 1, wherein the processor filters the one or more property listings based on the received geolocation data and a predetermined distance from the user device.

7. The system of claim 1, wherein the processor
generates a unique Uniform Resource Locator (URL) for the first property listing, the URL referencing a website associated with the first property listing, and
transmits the unique URL to the user device.

8. The system of claim 7, wherein the user device displays the website associated with the first property listing and referenced by the URL, the first property listing including a property summary and property information, the property summary including one or more of an address, a number of bedrooms, a number of bathrooms, and a square footage associated with the first property listing, and the property information including one or more of an age, a floor type, and a lot size associated with the first property listing.

9. The system of claim 7, wherein the user device displays, via a web browser, one or more of an interactive street view of the first property listing, an interactive street view of a neighborhood associated with the first property listing, and a virtual tour of the first property listing.

10. The system of claim 7, wherein the first property is a multiple unit property and the user device displays one or more filter buttons for filtering units of the multiple unit property.

11. The system of claim 1, wherein the system is a centralized portal and provides one or more of a real estate professional, a buyer, a seller, and an insurer access to the one or more property listings associated with the listing entity from the database.

12. A method for database querying using at least one machine-readable optical code, comprising the steps of:
receiving machine-readable optical code information associated with a listing entity from a user device;
determining the listing entity based on the received computer-readable optical code information;
retrieving one or more property listings associated with the listing entity from the database;
receiving geolocation data of the user device;
filtering the one or more property listings based on the received geolocation data to determine a first property listing having a closest proximity to the user device; and
transmitting the first property listing to the user device.

13. The method of claim 12, wherein
the machine-readable optical code is a Quick Response (QR) code, and
the listing entity is one of a real estate brokerage, a real estate broker, a real estate agency, a real estate agent, a realtor, and a bank.

14. The method of claim 12, wherein the user device is one of a smart phone, a tablet, a personal digital assistant, and a cloud-based computing platform.

15. The method of claim 12, wherein property associated with the property listing is one of a single family home, an apartment building, an apartment, a condominium, a townhouse, a commercial building, an automobile, and a watercraft.

16. The method of claim 12, further comprising the step of filtering the one or more property listings based on the received geolocation data and a predetermined distance from the user device.

17. The method of claim 12, further comprising the steps of:
generating a unique Uniform Resource Locator (URL) for the first property listing, the URL referencing a website associated with the first property listing, and
transmitting the unique URL to the user device.

18. The method of claim 17, further comprising the step of:
displaying, on the user device, the website associated with the first property listing and referenced by the URL,
wherein the first property listing includes a property summary and property information, the property summary including one or more of an address, a number of bedrooms, a number of bathrooms, and a square footage associated with the first property listing, and the property information includes one or more of an age, a floor type, and a lot size associated with the first property listing.

19. The method of claim 17, further comprising the step of:
displaying, on the user device via a web browser, one or more of an interactive street view of the first property listing, an interactive street view of a neighborhood associated with the first property listing, and a virtual tour of the first property listing.

20. The method of claim 17, further comprising the steps of:
determining that the first property is a multiple unit property; and
displaying, on the user device, one or more filter buttons for filtering units of the multiple unit property.
